(19) United States
(12) Patent Application Publication
(10) Pub. No.: US 2025/0083666 A1
(43) Pub. Date: Mar. 13, 2025

(54) METHOD FOR CONTROLLING A VEHICLE AND AVOIDING OBSTACLES

(71) Applicants: AMPERE S.A.S., Boulogne Billancourt (FR); INSTITUT NATIONAL DE RECHERCHE EN INFORMATIQUE ET EN AUTOMATIQUE, LE CHESNAY-ROCQUENCOURT (FR); Nissan Motor Co., Ltd, Kanagawa (JP)

(72) Inventors: Anh-Lam DO, Antony (FR); Christian LAUGIER, Montbonnot Saint-Martin (FR); Philippe MARTINET, Juan les Pins (FR); Luiz-Alberto SERAFIM-GUARDINI, Fontenay-le-Fleury (FR); Anne SPALANZANI, Grenoble (FR)

(21) Appl. No.: 18/292,453

(22) PCT Filed: Jul. 26, 2022
(86) PCT No.: PCT/EP2022/070878

§ 371 Date: Jan. 26, 2024

(30) Foreign Application Priority Data
Jul. 27, 2021 (FR) 2108170

(51) Int. Cl. B60W 30/09; B60W 10/18; B60W 10/20; B60W 50/00; B60W 60/00

(52) U.S. Cl. CPC B60W 30/09; B60W 10/18; B60W 10/20; B60W 50/0098; B60W 2050/0022; B60W 60/0015; B60W 2710/18; B60W 2710/20

(57) ABSTRACT

A method for controlling a motor vehicle includes: determining an initial trajectory for the motor vehicle; acquiring data relating to the surroundings of the motor vehicle; calculating a risk of the motor vehicle colliding with an obstacle, taking into account the determined initial trajectory and the acquired data and, then, if the risk of colliding with the obstacle exceeds a risk threshold; calculating a time to collision and, then, if the time to collision is below a time threshold; and activating a warning driving mode according to which: a new trajectory is determined by the computer, the new trajectory allowing minimizing the risk of collision with the obstacle causing a serious injury, and an actuator for controlling the steering of the motor vehicle is controlled by the computer to follow the new trajectory.

### TECHNICAL FIELD OF THE INVENTION

The present invention generally relates to the safety of vehicles, in particular for avoiding collisions between a vehicle and an object present in its surroundings.

More particularly, it relates to a method for controlling a motor vehicle allowing avoiding an obstacle or, if this is a priori not possible, minimizing the risks of impact and the risks of serious injury.

### PRIOR ART

Many vehicles are nowadays equipped with active safety systems allowing evaluating the surroundings in which the vehicle evolves and controlling the vehicle accordingly. Among these systems, mention may be made of drive assist systems (“Advanced Driver-Assistance Systems” or ADAS according to the English acronym commonly used) which will activate, for example, the autonomous emergency braking (“Advanced Emergency Braking” or AEB) or the autonomous emergency steering (“Autonomous EmergencySteering” or AES).

If a danger exists in the surroundings of the vehicle, this type of system generally intervenes only as a last resort, by correcting the kinematics (speed and/or trajectory) of the vehicle.

New methods for mitigating the risks of collision are developed in order to minimize the severity of the collision when the latter is unavoidable. Thus, the document US2016001775A1 provides a solution according to which, when an imminent collision is detected, a new trajectory is established so as to prevent or minimize any body injury.

Nonetheless, one problem is how to accurately and effectively determine whether or not a risk of collision is really imminent, so as not to unnecessarily trigger an emergency procedure.

### DISCLOSURE OF THE INVENTION

In order to overcome the aforementioned drawback of the prior art, the present invention provides a method for controlling a motor vehicle comprising, when the motor vehicle is driven in a nominal mode (for example a manual driving mode by a driver or an autonomous driving mode by a computer), steps of:
determining an initial trajectory for the motor vehicle, predicted in particular from dynamic information of the vehicle,
acquiring data relating to the surroundings of the motor vehicle,
calculating a risk of the motor vehicle colliding with an obstacle taking into account the determined initial trajectory and the acquired data, then, if the risk of colliding with the obstacle exceeds a risk threshold,
calculating a time to collision, then, if the time to collision is less than a time threshold,
activating a warning driving mode according to which:
a new trajectory is determined by the computer, said new trajectory allowing minimizing the risk of colliding with the obstacle causing a serious injury, and
a an actuator for controlling the steering of the motor vehicle is controlled by the computer to follow said new trajectory.

Thus, thanks to the invention, triggering of the emergency driving mode, in which the vehicle is controlled according to an avoidance trajectory, is triggered only when this proves to be really necessary.

As will be clearly apparent in the following description, the invention proves to be particularly advantageous since it combines different technical solutions which interact so as to offer a new solution which is very safe for the occupants of the motor vehicle.

Thus, it allows assigning a risk of injury to each object of its surroundings, taking into account the accident history data that is known. It uses a perception method based on probabilistic occupancy grids. It allows managing the risks of impact and the risks of injury by performing a risk mitigation. It allows finding a collision-free trajectory whenever this is possible. It allows determining whether an emergency braking or an avoidance maneuver is preferable. Finally, it takes into account the dynamic capabilities of the vehicle and of the driver to calculate an obstacle avoidance trajectory.

Other advantageous and non-limiting features of the method according to the invention, considered individually or according to any technically-feasible combinations, are as follows:
the time threshold is equal to at least one amongst an emergency braking time and a reaction time of the driver;
the computer keeps the warning driving mode activated for a predetermined minimum duration, preferably comprised between two and four seconds;
   when the warning driving mode is activated, it is provided to regularly repeat steps of acquiring the data relating to the surroundings of the motor vehicle, of calculating a risk the motor vehicle colliding with another obstacle taking into account the new trajectory and the acquired data, then, if the risk of colliding with the other obstacle exceeds a risk threshold, calculating a time to collision with the other obstacle, then, if the time to collision is less than said time threshold, determining a second new trajectory allowing minimizing the risk of colliding with each obstacle causing a serious injury, and controlling said control actuator to follow said second new trajectory;
when the warning driving mode is activated, it is provided to control the return into the nominal mode as soon as the duration during which the emergency driving mode exceeds a predetermined threshold, preferably equal to six seconds;
when the warning driving mode is activated, it is provided to control the return into the nominal mode as soon as the new trajectory is free of any obstacle and that the motor vehicle has been stable for a predetermined duration;
the new trajectory is selected from among several test trajectories using a cost function, a value of said cost function being calculated for each test trajectory;
said value depends, when the test trajectory encounters an obstacle, on the speed of impact with the obstacle and on the type of the obstacle;
said value varies depending on whether the test trajectory departs from the road followed by the motor vehicle and/or the traffic lane followed by the motor vehicle and/or the traffic lanes authorized for the motor vehicle;
said value depends on:
   a first weight which is non-zero if the test trajectory departs from the traffic lane followed by the motor vehicle and which is zero otherwise, and
   a second weight which is non-zero and preferably greater than the first weight if the test trajectory departs from the road followed by the motor vehicle (100) and which is zero otherwise;
said value varies depending on whether the test trajectory deviates or not from the initial trajectory;
the new trajectory is selected from among several test trajectories using an MPPI-type algorithm;
said data are in the form of a probabilistic occupancy grid representative of the surroundings of the motor vehicle and containing information about the objects present in the surroundings of the motor vehicle.

Of course, the different features, variants and embodiments of the invention may be associated with one another according to various combinations to the extent that they are not incompatible with or exclusive of one another.

### DETAILED DESCRIPTION OF THE INVENTION

The following description with reference to the appended drawings, given as non-limiting examples, will explain the scope of the invention and how it could be carried out.

In the appended drawings:

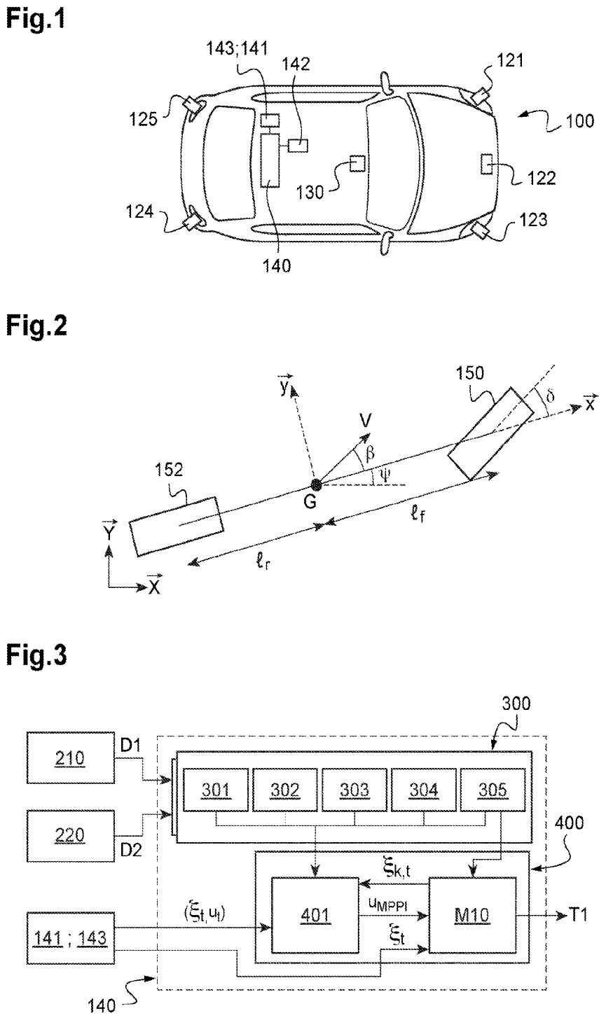

FIG. 1 is a schematic top view of a motor vehicle suitable for implementing a method in accordance with the invention;

FIG. 2 is an illustration of the “bicycle” model applied to the motor vehicle moving in a traffic lane;

FIG. 3 is a diagram illustrating a computer system for implementing the method in accordance with the invention;

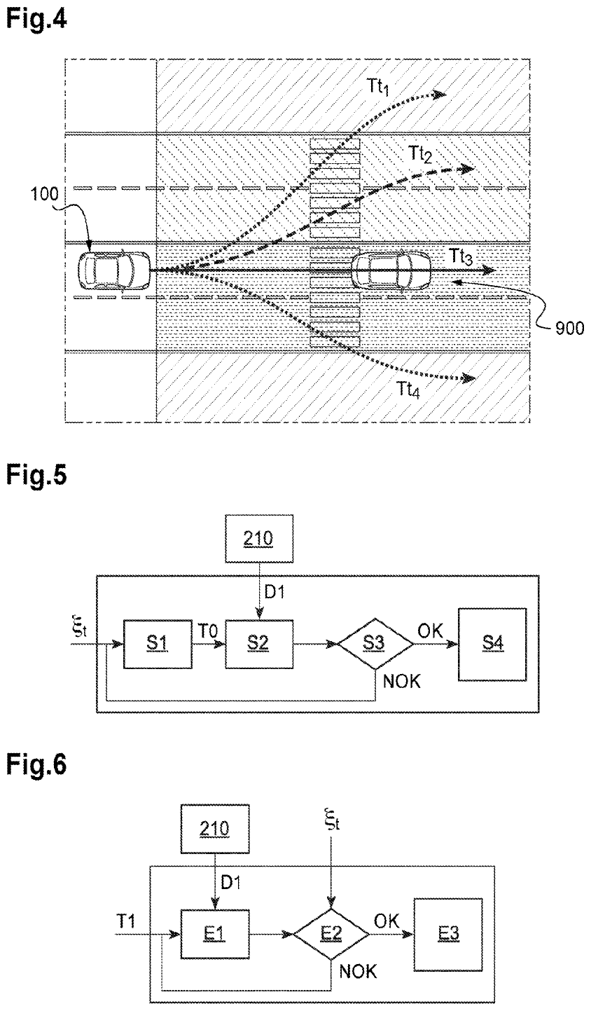

FIG. 4 is a schematic top view of the motor vehicle of FIG. 1 moving on a road;

FIG. 5 is a block diagram illustrating the various steps necessary for triggering an emergency driving mode;

FIG. 6 is a block diagram illustrating the different steps necessary for deactivating the emergency driving mode;

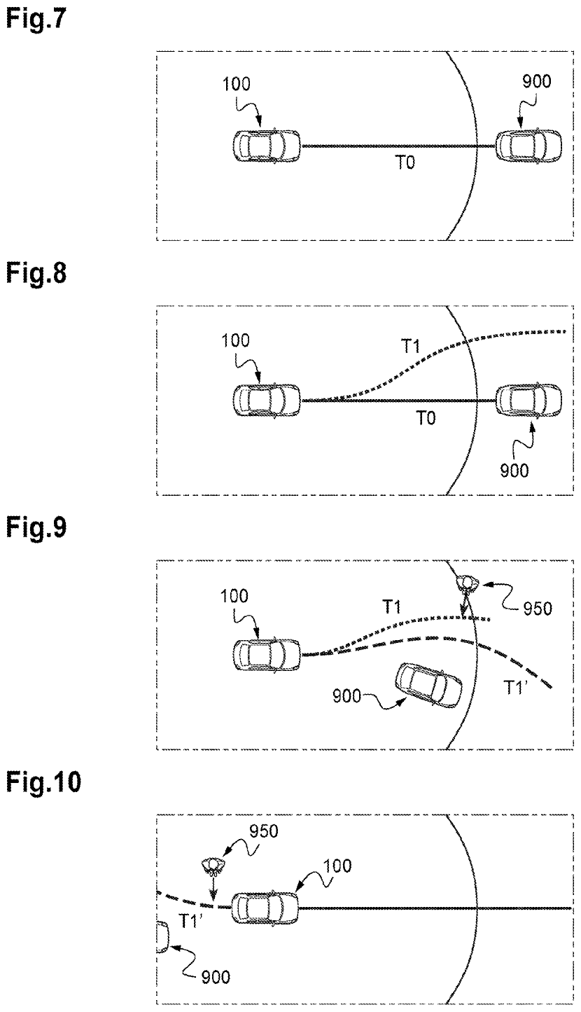

FIG. 7 is a schematic top view of the motor vehicle of FIG. 1 moving on a road on which there are obstacles, at a first time point;

FIG. 8 is a view illustrating the same situation as that illustrated in FIG. 7, at a second time point;

FIG. 9 is a view illustrating the same situation as that illustrated in FIG. 7, at a third time point;

FIG. 10 is a view illustrating the same situation as that illustrated in FIG. 7, at a fourth time point.

FIG. 1 shows a motor vehicle 100 viewed from above.

As shown in this figure, the motor vehicle 100 is herein a common car, including a chassis which is supported by wheels and which itself supports different pieces of equipment including a powertrain, braking means, and a steering unit.

Alternatively, it could consist of another type of vehicle (truck, utility vehicle, etc.).

This motor vehicle 100 is of the autonomous or semi-autonomous type, meaning that it includes equipment allowing controlling the speed and direction of the vehicle at least for a short duration of a few seconds.

It will be considered later on that it is an autonomous vehicle, i.e. a vehicle having the ability to evolve in its surroundings without intervention from the driver, to a destination entered by the driver.

This motor vehicle 100 is equipped with odometry sensors enabling identification thereof in its surroundings, for example in order to enable it to control itself autonomously and to evaluate its surroundings.

Any sensor type could be used.

In the example illustrated in FIG. 1, the motor vehicle 100 is equipped with a camera 130 directed forwards of the motor vehicle 100 in order to capture images of the surroundings located at the front of the motor vehicle 100.

The motor vehicle 100 is further equipped with at least one ranging sensor (RADAR, LIDAR or SONAR). More specifically, it is herein equipped with five LIDAR sensors 121, 122, 123, 124, 125 located at the four corners of the motor vehicle and at the front central position of the motor vehicle.

The motor vehicle 100 is also equipped with a navigation system 141, comprising for example a GNSS receiver (typically a GPS sensor), a map storage memory, and a calculation unit adapted to identify the position of the vehicle on these maps.

It may also include an inertial unit 143 allowing determining the amount of movement of the vehicle between two time points.

In order to process the information provided by these different components, the motor vehicle 100 is equipped with a computer 140.

This computer 140 includes at least one processor (CPU), at least one internal memory, analog-to-digital converters, and different input and/or output interfaces.

Thanks to its input interfaces, the computer 140 is adapted to receive input signals originating from the different sensors.

Moreover, the computer 140 is connected to an external memory 142 which stores different data such as, for example, predetermined data that will be presented hereinafter.

In turn, the internal memory of the computer 140 stores a computer application, consisting of computer programs comprising instructions the execution of which by the processor allows implementing the method described hereinafter by the computer 140.

Finally, thanks to its output interfaces, the computer 140 is adapted to transmit instructions to different members of the motor vehicle. For example, these members consist of a power steering actuator, a brake actuator, an enclosure located in the passenger compartment of the vehicle, a display screen located in the passenger compartment of the vehicle, a vibrating motor located in the steering wheel of the vehicle.

It will be considered in the following description that the computer is formed by several distinct entities but, alternatively, it could comprise one single entity adapted to carry out all of the actions presented hereinafter.

In the following description, we will disclose in the following order:
how the movement of the motor vehicle 100 can be modelled,
how, based on this modeling, a reference trajectory can be calculated if an obstacle is on the initial trajectory T0 of the vehicle so as to enable the vehicle to avoid this obstacle without the driver having to intervene (or at least minimize the consequences of an impact if it is not possible to avoid the obstacle), and
which are the conditions required to switch from an initial driving mode (also called the nominal mode) into an emergency driving mode in order to avoid the obstacle by following the reference trajectory, and vice-versa.

The trajectory of the motor vehicle 100 is herein modeled by a so-called “bicycle” model illustrated in FIG. 2. In the context of this model, as shown in FIG. 2, the motor vehicle 100 is illustrated by a frame and two wheels 150, 152 (like a bicycle).

The model is described by the following system of equations:

$$\{ \begin{matrix}\dot{X} = V cos ( ψ + β ( δ ) ) \\ \dot{Y} = V sin ( ψ + β ( δ ) ) \\ \dot{ψ} = \frac{V}{{l}_{r}} sin ( β ( δ ) )\end{matrix} \qquad [ Math . 1 ]$$

The variables considered in this model are as follows:
the variables X and Y which correspond to the coordinates of the center of gravity of the motor vehicle 100 in the reference frame (X, Y) attached to the traffic lane,
the variable V which corresponds to the speed of the motor vehicle 100,
a steering angle, denoted δ, of the front wheel 150, i.e. the angle formed by the front wheel 150 with the longitudinal axis of the motor vehicle 100,
a heading angle, denoted ψ, corresponding to the angle, so-called the yaw angle, between the longitudinal axis of the motor vehicle 100 and the tangent to the trajectory,
the variable β(δ) defined in the following manner:

$$β ( δ ) = ( tan ( δ \cdot \frac{{l}_{r}}{{l}_{r} + {l}_{f}} ) ) \qquad [ Math . 2 ]$$

In this equation, the terms I_{f} and Iᵣ respectively represent the distances between the center of gravity G of the motor vehicle 100 and the axis of the front axle and of the rear axle.

Hence, the state (and therefore the trajectory) of the motor vehicle 100 may be characterized by the set ξ defined by the equation:

$$ξ ( t ) = [ X ( t ) , Y ( t ) , ψ ( t ) , V ( t ) ] \qquad [ Math . 3 ]$$

It is also possible to introduce an input variable u(t) defined by the equation:

$$u ( t ) = [ dV ( t ) / dt , δ ( t ) ] \qquad [ Math . 4 ]$$

At this stage, it is now possible to explain how to calculate the reference trajectory T1 which will allow, when at least one potentially dangerous obstacle will be detected, avoiding each obstacle when this is possible or reducing the risks of injury if this is not possible.

As shown in FIG. 3, the computer 140 receives as input data D1 representative of the surroundings of the motor vehicle. These data D1 are elaborated by an entity 210 that is third-party to the computer 140, in particular according to the data gathered by the sensors of the vehicle (camera, LIDAR sensors, etc.).

These data D1 are herein in the form of a probabilistic occupancy grid containing information on the semantics of the objects.

The technique used to generate these data D1 is already known to a person skilled in the art and will not be described in detail. We could just state that it is in accordance with the solution taught in the document “L. Rummelhard, A. Negre and C. Laugier, “Conditional Monte Carlo Dense Occupancy Tracker,” 2015 IEEE 18th International Conference on Intelligent Transportation Systems, Las Palmas, 2015, pp. 2485-2490”.

Nonetheless, it is possible to specify that the grid is formed of a plurality of cells and is centered on the vehicle or at the front of the latter. The characteristic dimensions of this grid depend on the size of the surroundings that it is desired to apprehend (it could thus vary according to the speed of movement of the motor vehicle 100).

This illustration comprises a first set of data characterizing the motor vehicle 100 (for example its location and its kinematic data) and a second set of data relating to the objects identified in the surroundings, in particular their location, their direction and their speed of movement.

As also shown in FIG. 2, the computer 140 also receives as input data D2 representative of severity curves derived from the accident history, stored in a memory 220.

These severity curves allow associating with each detected object a probability of collision with a risk of injury.

The technique used to establish these data D2 is already known to a person skilled in the art and will not be described in detail. We could just state that it complies with the solution taught in the document “L. A. Serafim Guardini, A. Spalanzani, C. Laugier, P. Martinet, A.-L. Do and T. Hermitte, “Employing Severity of Injury to Contextualize Complex Risk Mitigation Scenarios,” 2020 IEEE Intelligent Vehicles Symposium (IV), Las Vegas, NV, USA, 2020, pp. 1839-1845, doi: 10.1109/IV47402.2020.9304543”.

To sum up, this technique allows determining a risk of injury for each detected object. This risk of injury is determined according to a plurality of data associated with each object. These data are derived from injury risk curves built from statistical analysis data of accidents. In particular, the data derived from these injury risk curves correspond to an illustration of the variation in the severity of the injury caused by the collision according to the impact speed and the object type (vehicle, pedestrian, bicycle, inert object, etc.). For example, they allow distinguishing the probability of light injuries (requiring less than 24 hours of hospitalization or no hospitalization), serious injuries (requiring 24 hours to 30 days of hospitalization) or deadly injuries (related to an accident within 30 days). The risk of injury associated with each object type is determined by calculating a weighted sum of probabilities of deaths, serious injuries and light injuries associated with the determined impact speed.

As also shown in FIG. 3, the computer 140 also receives as input odometry data ξₜ, Uₜ of the vehicle.

For example, these data are obtained thanks to the navigation system 141 and the inertial unit 143 equipping the motor vehicle 100.

The operation of the computer 140 for calculating the reference trajectory T1 according to all these data could be schematized into two blocks, namely a constraint calculation block 300 and a trajectory plotting block 400.

The constraint calculation block 300 allows establishing, based on the data D1, D2, constraints:
301—probability of collision with risk of injury,
302—trajectory to be followed,
303—dynamics of the vehicle,
304—perception of the surroundings, and
305—controllability of the vehicle.

In particular, such constraints are mentioned in the patent document filed under the reference FR2007743, on Jul. 23, 2020.

Nonetheless, it is possible to define, as an example, the controllability constraints (305).

In this case, these constraints are three in number.

A first controllability constraint aims to limit the steering angle that the power steering actuator can impose on the steering wheel. Indeed, it is desired that the steering angle δ remains comprised between two lower δmin and upper δmax limits so that the driver could be able to resume driving of the vehicle at any time.

A second controllability constraint aims to limit the steering speed that the power steering actuator can impose on the steering wheel. Indeed, it is desired that the steering speed dδ/dt remains comprised between two lower Smin and upper Smax limits, for the same reasons as mentioned before.

A third controllability constraint aims to limit the acceleration experienced by the motor vehicle 100. Indeed, it is desired that the acceleration dV/dt remains comprised between two lower Amin and upper Amax limits.

In turn, the trajectory plotting block 400 allows determining the optimum reference trajectory T1 which minimizes the overall risk of injury, either by avoiding obstacles, or by mitigation (by minimizing the probability of collision with the risk of injury).

In this block, several test trajectories Ttₖ will be randomly defined (preferably more than 100, and even more preferably more than 1,000), then a cost qₖ associated with each test trajectory Ttₖ will be calculated, and one single trajectory will then be selected.

An example of a method allowing determining this reference trajectory T1 is for example taught in the aforementioned patent document FR2007743.

In this example, the plurality of test trajectories Ttₖ is determined for a time window in the range of a few seconds (for example, in the range of 3 seconds).

By “test trajectories”, it should be understood the trajectories that the motor vehicle 100 could follow by maneuvering in a reasonable manner, given the aforementioned constraints. For example, a trajectory according to which the motor vehicle 100 would move in reverse is not considered as a test trajectory.

Each of these test trajectories Ttₖ is determined using the previously-described bicycle model M10, on the aforementioned time window, given the current position of the motor vehicle 100. FIG. 4 shows as an example four possible test trajectories Tt₁, Tt₂, Tt₃, Tt₄.

One of the main objectives for the computer 140 is then to determine, from among this plurality of possible test trajectories Ttₖ, that one which will minimize the probability of collision causing a wound. For this purpose, the reference trajectory T1 to be followed is determined by optimizing a cost function.

Several types of algorithms using a cost function could be used. For example, the aforementioned patent document FR2007743 describes an example thereof.

Nonetheless, in this case, an MPPI-type (English acronym for “Model Predictive Path Integral”) algorithm 401 will be preferred. For example, such an algorithm is described in the document “G. Williams, P. Drews, B. Goldfain, J. M. Rehg and E. A. Theodorou, “Aggressive driving with model predictive path integral control,” 2016 IEEE International Conference on Robotics and Automation (ICRA), Stockholm, Sweden, 2016, pp. 1433-1440, doi: 10.1109/ICRA.2016.7487277”. Other algorithms based on this solution could also be used.

The main idea of these MPPI algorithms is to transform the cost function of an optimum control problem into the expectation of all possible trajectories. This allows solving the stochastic optimum problem with a probabilistic approximation (of the Monte Carlo type) using a direct sampling of a stochastic diffusion process. The MPPI algorithm determines a control sequence that minimizes the overall cost at each iteration. This cost corresponds to the integral of each individual cost at each step in which the solution of the Hamilton-Jacobi-Bellman equation is approximated using the Feynman-Kac theorem and the KL divergence as described in the aforementioned document by Wlliams et al. The use of the MPPI algorithm is attractive because it consists of a derivative-free optimization method, which enables the use of non-linear and non-convex cost models and functions, and having demonstrated good performances in aggressive driving situations is therefore particularly well suited to emergency trajectories in the context of driving aids.

Preferably, this algorithm will be implemented by a particular entity of the computer, namely by a graphics computing entity GPU.

Thus, this algorithm 401 provides a method for selecting, from among the test trajectories Ttₖ, that one which is optimum by using a cost function qₖ.

While the algorithm is well known and will therefore not be described here, it is however possible to specify how this cost function qₖ is defined here.

This cost function qₖ, the value of which is to be calculated for each test trajectory Ttₖ, is here equal to the sum of several components c_{PCIR}, c_{Lane}, c_{Reference}, c_{control}, c_{variance} allowing taking into account different constraints (surroundings, controllability, etc.).

These components are herein five in number. Alternatively, as will be further described hereinafter, other components could also be used.

Hence, the cost function is herein defined by the following mathematical equation.

$${q}_{k} = {c}_{PCIR} + {c}_{Lane} + {c}_{Reference} + {c}_{Control} + {c}_{Variance} \qquad [ Math . 5 ]$$

The component c_{PCIR} corresponds to the cost associated with a collision. It allows taking into account the risk of collision and the associated risk of injury.

This component is herein calculated as follows:

$${c}_{PCIR} = {w}_{PCIR} \cdot {α}_{PCIR} \cdot {β}_{PCIR} \qquad [ Math . 6 ]$$

In this equation, the term w_{PCIR} is the weight assigned to this component c_{PCIR}. For example, this weight is predetermined and stored in the memory of the computer.

The value of this weight, like that of the other weights described hereinafter, could be adjusted using road tests.

The term β_{PCIR} is a Boolean which takes the value 0 if the considered test trajectory Ttₖ is free (with no obstacles) and the value 1 if an obstacle is on this trajectory (which is the case of the sole test trajectory Tt₃ in FIG. 4).

The term α_{PCIR} is calculated according to the speed of impact with the obstacle (in the event of an obstacle on the test trajectory) and the semantics of this object (in particular the obstacle type). It is even greater as the impact speed is high, and it is greater for a pedestrian-type obstacle than for an inert obstacle (a tree branch for example).

The component c_{Lane} of the cost function qₖ is intended to ensure that the value of the cost function is lower for a test trajectory Ttₖ that does not departs from the traffic lane of the vehicle than a trajectory that departs therefrom, in order to constrain the vehicle as much as possible not to go on the opposite traffic lane and not to exceed the limits of the road (in particular if there are safety barriers on both sides of the road).

This component is herein calculated as follows:

$${c}_{Lane} = {w}_{Lane} + {w}_{limit} \qquad [ Math . 7 ]$$

Hence, it is equal to the sum of a first weight w_{Lane} which penalizes any test trajectory Ttₖ that would overpass the limits of the authorized traffic lane(s), and of a second weight wₗᵢₘᵢₜ which further penalizes any trajectory that would overpass the limits of the road.

The first weight w_{Lane} has a zero value if the test trajectory Ttₖ remains on the authorized traffic lane(s), and a non-zero value otherwise. Thus, this first weight allows defining a soft constraint enabling the vehicle to depart from the authorized traffic lanes, for example by crossing a white line, if no better trajectory is possible. Preferably, its non-zero value is comprised between the component c_{Reference} and the component c_{Control}. In this way, when it is different from zero, the first weight has a value that is sufficient to have an influence on the cost function, but not too great so as not to be too restrictive.

The second weight wₗᵢₘᵢₜ has a zero value if the test trajectory Ttₖ remains on the road and a non-zero value otherwise. Thus, this second weight allows defining a harder constraint in order to avoid the vehicle departing from the road. Preferably, its non-zero value is greater than that of the weight w_{PCIR}. In this way, this value proves to be sufficiently restrictive to never overpass the limits of the road, even in case of mitigation.

To better illustrate the different values that the component c_{Lane} could take, the test trajectories illustrated in FIG. 4 may be considered.

In this figure, the motor vehicle 100 travels on a road comprising four traffic lanes, two in a first direction (that one in which the motor vehicle 100 circulates) and two in an opposite direction. The two first traffic lanes are separated from each other by a continuous white line. In turn, the road is separated from the road verge by other white lines.

The component c_{Lane} of the cost function qₖ will have a very high value for the test trajectories Tt₁ and Tt₄ which make the motor vehicle 100 depart from the road. It will have a zero weight for the test trajectory Tts which does not require the vehicle 100 to depart from its traffic lane. And it will have an intermediate value for the test trajectory Tt₂ which requires that the vehicle 100 crosses the central continuous white line.

The component c_{Reference} of the cost function qₖ allows preferably selecting a test trajectory Ttₖ which is as close as possible to the initial trajectory T0 of the vehicle.

This initial trajectory T0 is that one the motor vehicle 100 was intended to follow before an emergency maneuver is triggered to avoid an obstacle located on this initial trajectory T0. It is calculated conventionally, for example according to the dynamic data of the vehicle (speed, acceleration, steering angle, steering speed, etc.). It could be obtained otherwise. For example, it is possible to consider that it is formed by the central trajectory of the traffic lane followed by the vehicle.

This component c_{Reference} is herein calculated by means of the following equation:

$${c}_{Reference} = {( ξ - {ξ}_{ref} )}^{T} {w}_{Reference} ( ξ - {ξ}_{ref} ) \qquad [ Math . 8 ]$$

In this equation, the term ξ comprises several states, including the state that the vehicle initially has while it still follows the initial trajectory T0 and the emergency maneuver has not yet been triggered, and successive states within a prediction window of at least one second, herein equal to 3 seconds, if the vehicle follows the initial trajectory T0.

The term ξ_{ref} corresponds to the state that the vehicle will have if it follows the considered test trajectory Ttₖ, after three seconds.

Hence, the difference between these terms ξ and ξ_{ref} allows comparing the states of the vehicle at several successive time steps included in the prediction window.

The term w_{Reference} is the weight assigned to the component c_{Reference}. The states ξ, ξ_{ref} being column matrices, this term w_{Reference} could be a positive defined square matrix which complies with the size of the problem, the values of which are predetermined and recorded in the memory of the computer 140.

The component c_{control} and the component c_{variance} of the cost function qₖ are convex costs defined in the aforementioned document “G. Williams, P. Drews, B. Goldfain, J. M. Rehg and E. A. Theodorou, “Aggressive driving with model predictive path integral control,” 2016 IEEE International Conference on Robotics and Automation (ICRA), Stockholm, Sweden, 2016, pp. 1433-1440, doi: 10.1109/ICRA.2016.7487277”.

Thus, the component c_{control} is calculated as follows:

$${c}_{Control} = \frac{1}{2} ( γ [ {u}_{t}^{T} {\sum }^{- 1} {u}_{t} + 2 {u}_{t}^{T} {\sum }^{- 1} {ϵ}_{t} ] ) \qquad [ Math . 9 ]$$

In this equation, the term γ is defined by the equation:

$$γ = λ ( 1 - α ) \qquad [ Math . 10 ]$$

The term α is comprised between 0 and 1. It allows setting the aggressiveness of the controller with regards to the variance of the process.

The parameter λ corresponds to the desired aggressiveness of the controller.

The matrix Σ is a diagonal matrix comprising weights for the variable input uₜ and the Gaussian noise ξₜ used in the context of the MPPI algorithm.

In turn, the component c_{variance} is calculated by means of the following equation:

$${c}_{variance} = λ [ ( 1 - {v}^{- 1} ) {ϵ}_{t}^{T} {\sum }^{- 1} {ϵ}_{t} ] \qquad [ Math . 11 ]$$

In this equation, the term v corresponds to the variance of the Gaussian noise used in the context of the MPPI algorithm.

As set out hereinabove, alternatively, the cost function qₖ could be equal to the sum of the aforementioned components and of at least one other component, herein called a component c_{Terminal}.

In this variant, the component c_{Terminal} is calculated as follows:

$${c}_{Terminal} = {w}_{Terminal} ( ξ - {ξ}_{T} ) \qquad [ Math . 12 ]$$

In this equation, the term ξ_{T} corresponds to the state that the vehicle will have if it follows the test trajectory up to a final state, corresponding to the end of the obstacle avoidance procedure.

The term w_{Terminal} is the weight assigned to the component c_{Terminal}. The states ξ, ξ_{T} being column matrices, this term w_{Terminal} could be a row matrix comprising several non-zero values predetermined and recorded in the memory of the computer 140.

Thanks to the cost function used and calculated for each test trajectory Ttₖ, the computer 140 is able to implement the MPPI algorithm and to select the optimum test trajectory (called the reference trajectory T1).

This reference trajectory T1 is then stored in its memory.

Preferably, it will be a collision-free trajectory. In a situation where all considered test trajectories would cause a collision, the selected trajectory would be that one which would minimize the risks of collision and serious injuries.

At this stage of the description, it is possible to explain when the computer 140 switches from a nominal driving mode into an emergency driving mode.

The nominal driving mode is that one in which the vehicle is controlled either manually by the driver, or autonomously by an entity of the computer.

The case where it is driven in an autonomous mode will be herein considered.

For example, in this mode, the motor vehicle 100 is controlled so as to remain centered on its traffic lane and to maintain its speed equal to a setpoint speed (constant or determined according to the speed of a vehicle that precedes it on its lane).

The question that arises at any time is to determine whether to keep the vehicle in the autonomous driving mode or to switch it into an emergency driving mode in order to attempt to avoid a potentially dangerous obstacle.

FIG. 5 shows a first diagram illustrating a method that enables the computer 140 to determine, when the vehicle is in the autonomous mode, whether or not it should switch into the emergency driving mode.

According to this method, during a first step S1, the computer determines the initial trajectory T0 to follow considering the destination to be reached, for example such that the vehicle remains centered on its lane.

This initial trajectory T0 is calculated for a horizon of at most a few seconds but of at least two seconds. This initial trajectory T0 is herein calculated for the next three seconds.

During a second step S2, the computer determines, while taking into account the obtained data D1 representative of the surroundings, whether there is a risk that the motor vehicle 100 collides with any obstacle if it follows the initial trajectory T0.

For this purpose, the computer determines a probability of collision according to the position and the dynamics of the motor vehicle 100 and of each detected object occupying a cell of the grid of the considered representation.

During a third step S3, the computer seeks to check whether two cumulative conditions are met.

The first condition is that a risk of collision exists. The computer herein considers that there is a risk of collision if the probability of collision calculated for at least one of the objects detected (hereinafter called the “obstacle”) exceeds a predetermined risk threshold.

The second condition is that a time to collision TTC with this obstacle is less than a determined time threshold t_{crit}.

For example, the time to collision TTC may be equal to the time necessary for the motor vehicle 100 to hit the obstacle, taking into account its speed, from that of the obstacle and from the distance separating the vehicle from the obstacle.

A more accurate method for calculating the time to collision TTC is described in more detail in the document “On computing time-to-collision for automation scenarios”, C Schwarz, Transportation Research Part F: Traffic Psychology and Behavior, Vehicle Automation and Driver Behavior, vol. 27, pp. 283-294, 2014”.

The time threshold t_{crit} is equal to the minimum amongst:
an emergency braking time, and
a reaction time of the driver.

For example, the emergency braking time corresponds to the time required to stop the motor vehicle, given the set constraints.

For example, the reaction time of the driver is a constant predetermined and stored in the memory of the computer. This reaction time of the driver is herein selected equal to 2 seconds.

During this step S3, if at least one of the two cumulative conditions is not met, the computer considers that no avoidance maneuver needs to be undertaken. Consequently, the vehicle remains controlled in the autonomous driving mode and the method resets to the first step S1.

Otherwise, the emergency driving mode is activated. Henceforth, a reference trajectory T1 is calculated in the manner set out hereinabove, then the control actuators of the motor vehicle 100 are controlled so that the motor vehicle 100 follows this reference trajectory T1 and autonomously avoids the obstacle.

This driving mode is designed to remain activated for a predetermined duration, for example equal to three seconds.

Nonetheless, when this mode is activated, the computer continues to attempt to detect new obstacles located on the reference trajectory T1. Then, if so is the case, a new reference trajectory is calculated in the same manner as mentioned before. In this situation, it should be understood that it might happen that the emergency driving mode remains activated for more than three seconds.

When the emergency driving mode is activated, it is necessary to repeatedly check whether it is appropriate to deactivate it.

FIG. 6 shows a second diagram illustrating a method that enables the computer 140 to determine, when the vehicle is in the emergency driving mode, whether it should switch back into the autonomous mode or remain in the emergency driving mode.

According to this method, during a first step E1, the computer 140 acquires the reference trajectory T1 stored in its memory and the data D1 representative of the surroundings. Thus, it is able to determine whether there is still a risk that the motor vehicle 100 collides with any obstacle if it follows the reference trajectory T1.

Then, during a second step E2, the computer 140 checks whether either one of several deactivation conditions are met. In this case, these conditions are not cumulative but independent.

One of these conditions is that the emergency driving mode has been activated for a duration greater than a maximum threshold. Preferably, this maximum threshold is equal to six seconds.

Thus, as soon as the duration of activation of the emergency driving mode exceeds six seconds, it is provided to leave it.

Another condition is that the trajectory is collision-free and that the motor vehicle 100 has been stable for a predefined duration (for example equal to one second). Thus, if no potentially dangerous obstacle is on the reference trajectory T1 and if the lateral speed and the yaw rate of the motor vehicle 100 have been lower than predetermined thresholds for one second, the vehicle automatically switches into the autonomous or manual driving mode.

In other words, if either one of the aforementioned conditions is met, during a step E3, the computer 140 deactivates the emergency driving mode, which amounts to reactivating the autonomous or manual driving mode.

To better understand how the solution operates, FIGS. 7 to 10 show an example wherein the motor vehicle 100 should change the driving mode.

Initially, at a time to illustrated in FIG. 7, the motor vehicle 100 is on the same lane as an obstacle 900 (in this case another vehicle), but at a considerable distance from the latter. It then remains driven in the autonomous mode at the center of its traffic lane, at a predefined setpoint speed. In parallel, the initial trajectory T0 and the time to impact TTC are regularly calculated.

Then, the motor vehicle 100 quickly approaching this obstacle 900, at a time point t₁ illustrated in FIG. 8, it is at a distance from the latter such that the two cumulative conditions for switching into the emergency driving mode are met. Henceforth, a reference trajectory T1 is calculated in the aforementioned manner. Afterwards, the actuators of the vehicle are controlled so that the vehicle best follows this reference trajectory T1, for a predetermined duration (for example equal to 3 seconds).

At the time point t₁ of switching into the autonomous mode, an audible and/or visual signal is sent to the driver to warn him/her of the situation.

During these three second of activation of the emergency driving mode, the computer checks whether a new obstacle is detected on the reference trajectory T1. In this case, a pedestrian 950 is detected at a time point t₂ illustrated in FIG. 9.

This new obstacle 950 located on the reference trajectory T1 at a distance such that the two cumulative conditions are met, the computer determines a second reference trajectory T1′.

This trajectory enables the motor vehicle 100 to avoid the two obstacles and to return to its initial traffic lane.

Finally, at a time point t₃ illustrated in FIG. 10, the trajectory T1′ being collision-free and the vehicle having been stable for more than one second, the control of the actuators return back to the autonomous driving mode.

This method using a contextualized cost map containing the probability of collision with the risk of injury (namely the probabilistic occupancy grid as defined in the French patent application 2007743 filed on the Jul. 23, 2020) allows planning trajectories that minimize the overall risk of injury (for the considered vehicle and all obstacles) in the case of an unavoidable collision and enables an integral decision-making consisting in giving the best solution for a given scenario, the solution being either avoidance or braking, or the combination of avoidance and braking.

1. A method for controlling a motor vehicle comprising, when the motor vehicle is driven in a nominal mode, steps of:
determining an initial trajectory for the motor vehicle,
acquiring data relating to the surroundings of the motor vehicle,
calculating a risk of the motor vehicle colliding with an obstacle taking into account the determined initial trajectory and the acquired data, then, if the risk of colliding with the obstacle exceeds a risk threshold,
calculating a time to collision, then, if the time to collision is below a time threshold,
activating a warning driving mode according to which:
a new trajectory is determined by the computer, said new trajectory allowing minimizing the risk of colliding with the obstacle causing a serious injury, and
an actuator for controlling the steering of the motor vehicle is controlled by the computer to follow said new trajectory.

2. The control method according to claim 1, wherein the time threshold is equal at least to one amongst an emergency braking time and a reaction time of the driver.

3. The control method according to claim 1, wherein the computer maintains the warning driving mode activated for a predetermined minimum duration.

4. The control method according to claim 1, in which, when the warning driving mode is activated, it is provided to regularly repeat steps of:
acquiring the data relating to the surroundings of the motor vehicle,
calculating a risk of the motor vehicle colliding with another obstacle taking into account the new trajectory and the acquired data, then, if the risk of colliding with the other obstacle exceeds a risk threshold,
calculating a time to collision with the other obstacle, then, if the time to collision is below said time threshold,
determining a second new trajectory allowing minimizing the risk of colliding with each obstacle causing a serious injury, and
controlling said control actuator to follow said second new trajectory.

5. The control method according to claim 1, wherein, when the warning driving mode is activated, it is provided to control the return into the nominal mode as soon as the duration during which the warning driving mode exceeds a predetermined threshold.

6. The control method according to claim 1, wherein, when the warning driving mode is activated, it is provided to control the return into the nominal mode as soon as the new trajectory is free of any obstacle and that the motor vehicle has been stable for a predetermined duration.

7. The control method according to claim 1, wherein the new trajectory is selected from among several test trajectories using a cost function, a value of said cost function being calculated for each test trajectory, said value depending, when the test trajectory encounters an obstacle, on the speed of impact with the obstacle and the type of the obstacle.

8. The control method according to claim 1, wherein the new trajectory is selected from among several test trajectories using a cost function, a value of said cost function being calculated for each test trajectory, said value varying depending on whether the test trajectory departs from the road followed by the motor vehicle or the traffic lane followed by the motor vehicle or the traffic lanes authorized for the motor vehicle.

9. The control method according to claim 8, wherein said value depends on: —a first weight which is non-zero if the test trajectory departs from the traffic lane followed by the motor vehicle and which is zero otherwise, and —a second weight which is non-zero and preferably greater than the first weight if the test trajectory departs from the road followed by the motor vehicle and which is zero otherwise.

10. The control method according to claim 1, wherein the new trajectory is selected from among several test trajectories using a cost function, a value of said cost function being calculated for each test trajectory, said value varying depending on whether the test trajectory deviates or not from the initial trajectory.

11. The control method according to claim 1, wherein the new trajectory is selected from among several test trajectories using an MPPI-type algorithm.

12. The control method according to claim 1, wherein said data are in the form of a probabilistic occupancy grid representative of the surroundings of the motor vehicle and containing information about the objects present in the surroundings of the motor vehicle.
